(19) United States
(12) Patent Application Publication
(10) Pub. No.: US 2002/0117595 A1
(43) Pub. Date: Aug. 29, 2002

(54) HORIZONTALLY ADJUSTABLE FIXTURE ATTACHMENT SYSTEM

(76) Inventor: Didier Bierjon, Audincourt (FR)

Correspondence Address: HOFBAUER ASSOCIATES, 205 N 1455 LAKESHORE ROAD, BURLINGTON, ON, L7S SJ1, CA

(21) Appl. No.: 09/793,621

(22) Filed: Feb. 27, 2001

(51) Int. Cl. F16M 13/00

(52) U.S. Cl. 248/551; 248/223.21

(57) ABSTRACT

A horizontally adjustable fixture attachment system comprises a main body panel including a first aperture. A fixture for mounting on the main body panel and has a first tenon member with a shaft portion terminating in an enlarged head portion. A locking plate has a horizontally extending first lower slot portion dimensioned to permit the head portion of the first tenon member to pass therethrough, and has a first upper slot portion extending from the first lower slot portion and horizontally dimensioned to receive the shaft portion of the first tenon member in horizontally close-fitting vertically sliding relation therewithin and to preclude passage of the head portion of the first tenon member therethrough. A latching means is mounted on the locking plate for frictional engagement of the head portion of the first tenon member as the shaft portion vertically moves towards the upper end of the first upper slot portion corresponding to the locking plate being vertically moved relative to the fixture and to the main body panel from the unlocked configuration to the locked configuration. The frictional engagement holds the first tenon member in vertically unmovable relation thereby to preclude movement of the fixture and the locking plate with respect to each other. A contact mechanism precludes horizontal movement of the locking plate and the fixture relative to the main body panel.

### FIELD OF THE INVENTION

The present invention relates to fixture attachment systems, and more particularly to horizontally adjustable fixture attachment systems for use in vehicles.

### BACKGROUND OF THE INVENTION

It is common when assembling a mechanical device from prefabricated parts to require a fine adjustment of the relative placement of the parts one to another during the assembly process, in order to ensure that the parts are aligned correctly one with respect to another once the assembly is completed.

Such availability of adjustment is especially necessary during the assembly of automobiles, particularly during the installation of headlamps. It is important that headlamps are placed accurately within their provided recess or with respect to the surrounding parts in order to ensure high quality fit and finish.

It is known in the automotive industry to mount headlamps on to a body panel by means of a lock plate, such as is disclosed in U.S. Pat. No. 5,420,762 to Lewis, entitled Automotive Headlamp Assembly Fastening System. In that patent, it is disclosed to fasten a headlamp onto one side of an autobody panel by means of a lock plate disposed on the opposite other side of the autobody panel. Studs from the headlamp extend through apertures in the autobody panel and also through apertures in the lock plate and head portions of the studs capture cooperating portions of the lock plate. Further, pins having expanded heads extend outwardly from the lock plate and project through apertures in the autobody panel to engage the autobody panel and thereby provide a latch type engagement, thus keeping the headlamp secured to the autobody panel.

A significant drawback of the fastening system as disclosed in the Lewis patent, is that there is no horizontal adjustment possible of the positioning of the headlamp, which therefore makes it virtually impossible to properly adjust the placement of the headlamp to ensure proper fitted finish.

It is an object of the present invention to provide a fixture attachment system that permits horizontal adjustments of fixtures during installation.

It is another abject of the present invention to provide a fixture attachment system that permits horizontal adjustment of automobile headlamp fixtures during installation.

### SUMMARY OF THE INVENTION

In accordance with the present invention there is disclosed a horizontally adjustable fixture attachment system comprising a main body panel defining a first plane having horizontal and vertical axes and including a first aperture extending through the panel, with the first aperture having a horizontal width. A fixture is provided for mounting on the main body panel and has a first tenon member extending from the fixture, the first tenon member having a shaft portion with a horizontal width narrower than the horizontal width of the first aperture by a distance defining the horizontal adjustment of the fixture attachment system, with the shaft portion terminating in an enlarged head portion having a horizontal width intermediate between the horizontal width of the shaft portion and the horizontal width of the first aperture. A locking plate defines first and second substantially planar faces, the planar faces being oriented substantially parallel to one another and being disposed, in all operative configurations, in substantially parallel overlapping relation to the first plane, with the first planar face being directed toward the main body panel. The locking plate has a horizontally extending first lower slot portion dimensioned to permit the head portion of the first tenon member to pass through the first lower slot portion when the fixture and the locking plate are placed relative to each other in an unlocked configuration, in which configuration the main body panel is interposed between the fixture and the main body panel, the shaft portion of the tenon member is within the first aperture and the first lower slot portion, and the head portion of the tenon member has passed through the first aperture and the first lower slot portion to protrude beyond the second planar face of the locking plate. The locking plate has a first upper slot portion extending from a lower end coalescent with the first lower slot portion and terminating in an upper end, the first upper slot portion being horizontally dimensioned to receive the shaft portion of the first tenon member in horizontally close-fitting vertically sliding relation therewithin as the shaft portion moves from the first lower slot portion into the first upper slot portion corresponding to the locking plate being vertically moved relative to the fixture and to the body panel from the initial unlocked configuration to a locked configuration. The first upper slot portion is further horizontally dimensioned to preclude passage of the head portion of the tenon member through the first upper slot portion, when the fixture, the main body panel and the locking plate are in the locked configuration. A latching means is mounted on the second substantially planar face of the locking plate adjacent to the first upper slot portion for frictional engagement of the head portion of the tenon member as the shaft portion vertically moves towards the upper end of the first upper slot portion corresponding to the locking plate being vertically moved relative to the fixture and to the main body panel from the unlocked configuration to the locked configuration, the frictional engagement holding the tenon member in vertically unmovable relation adjacent the upper end of the slot portion to prevent reverse vertical movement of the shaft portion relative to the first upper slot portion, thereby to preclude movement of the fixture and the locking plate with respect to each other. A contact means has first and second cooperating portions mounted one on each of the locking plate and the main body panel to engage one another in horizontally fixed relation when the fixture and the locking plate are in the locked configuration, thereby to preclude horizontal movement of the locking plate and the fixture relative to the main body panel.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinbelow.

### BRIEF DESCRIPTION OF THE DRAWINGS

The novel features which are believed to be characteristic of the horizontally adjustable fixture attachment system according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is an exploded perspective view of a preferred embodiment of the horizontally adjustable fixture attachment system according to the present invention;

FIG. 2 is a perspective view of the main body panel and fixture of the fixture attachment system of FIG. 1;

FIG. 3 is a front elevational view of the main body panel and fixture of FIG. 2;

FIG. 4 is a cross-sectional view of the main body panel and fixture of FIG. 3, taken along section line 4-4 of FIG. 3;

FIG. 5 is a cross-sectional view of the main body panel and fixture of FIG. 3, taken along section line 5-5 of FIG. 3;

FIG. 6 is a perspective view of the main body panel and fixture of FIG. 2, with the fixture having been mounted on the main body panel;

FIG. 7 is a front elevational view of the main body panel and fixture of FIG. 6;

FIG. 8 is a side elevational view of the main body panel and fixture of FIG. 7, taken along section line 8-8 of FIG. 7;

FIG. 9 is a side elevational view of the main body panel and fixture of FIG. 7, taken along section line 9-9 of FIG. 7;

FIG. 10 is a perspective view of the fixture attachment of FIG. 1, with the fixture having been mounted on the main body panel, as shown in FIG. 6, and further showing the locking plate about to be put in place to secure said mounting;

FIG. 11 is a perspective view similar to FIG. 10, but with the fixture and locking plate in an unlocked configuration;

FIG. 12 is a front elevational view of the fixture attachment system of FIG. 11;

FIG. 13 is a cross-sectional side elevational view of the fixture attachment system of FIG. 12, taken along section line 13-13 of FIG. 12;

FIG. 14 is a cross-sectional side elevational view of the fixture attachment system of FIG. 12, taken along section line 14-14 of FIG. 12;

FIG. 15 is a perspective view of the fixture attachment system of FIG. 10, with the locking plate being moved downwardly towards a locked configuration of the fixture and locking plate;

FIG. 16 is a front elevational view of the fixture attachment system of FIG. 15;

FIG. 17 is a cross section side elevational view of the fixture attachment system of FIG. 16, taken along section line 17-17 of FIG. 16;

FIG. 18 is a cross section side elevational view of the fixture attachment system of FIG. 16, taken along section line 18-18 of FIG. 16;

FIG. 19 is a perspective view of the fixture attachment system of FIG. 15, with the locking plate having been moved downwardly to a locked configuration of the fixture and locking plate;

FIG. 20 is a front elevational view of the fixture attachment system of FIG. 19;

FIG. 21 is a cross-sectional side elevational view of the fixture attachment system of FIG. 20, taken along section line 21-21 of FIG. 20; and,

FIG. 22 is a cross-sectional side elevational view of the fixture attachment system of FIG. 20, taken along section line 22-22 of FIG. 20.

### DETAILED DESCRIPTION OF A PREFERRED EMBODIMENT

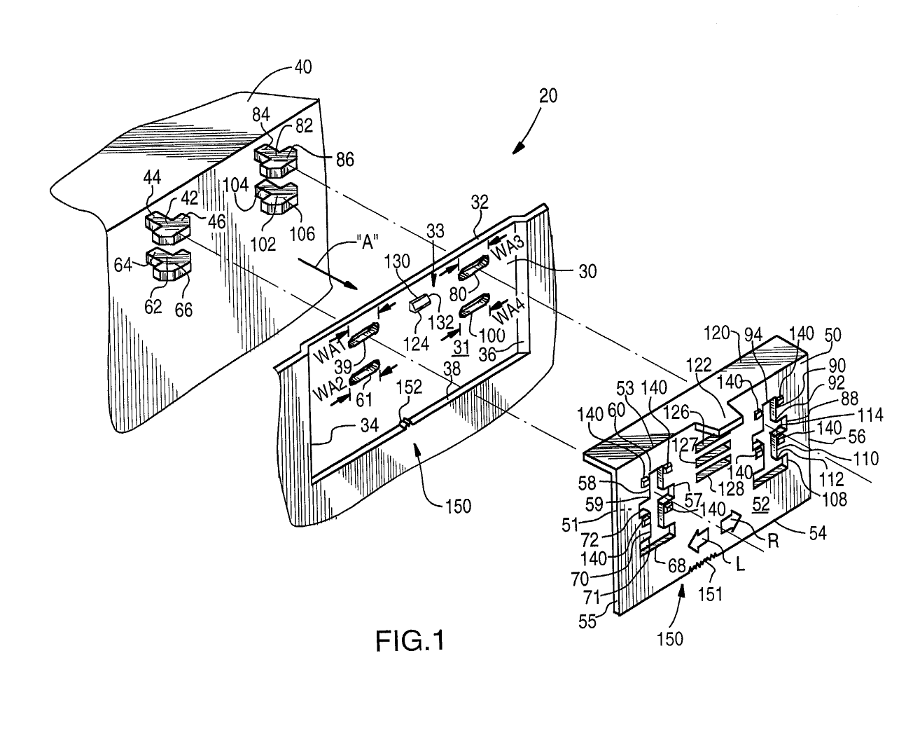

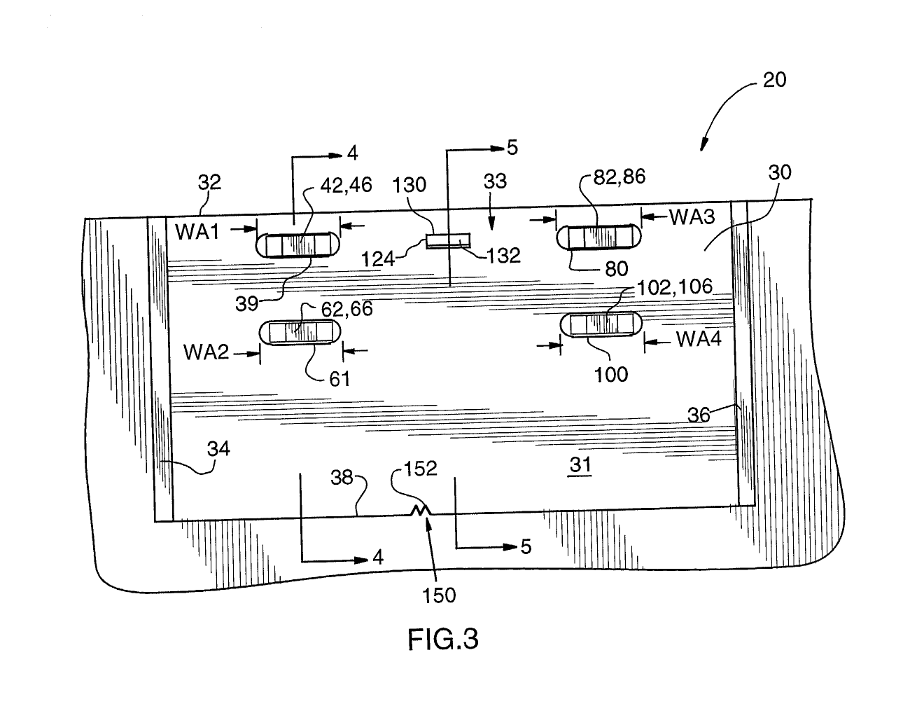

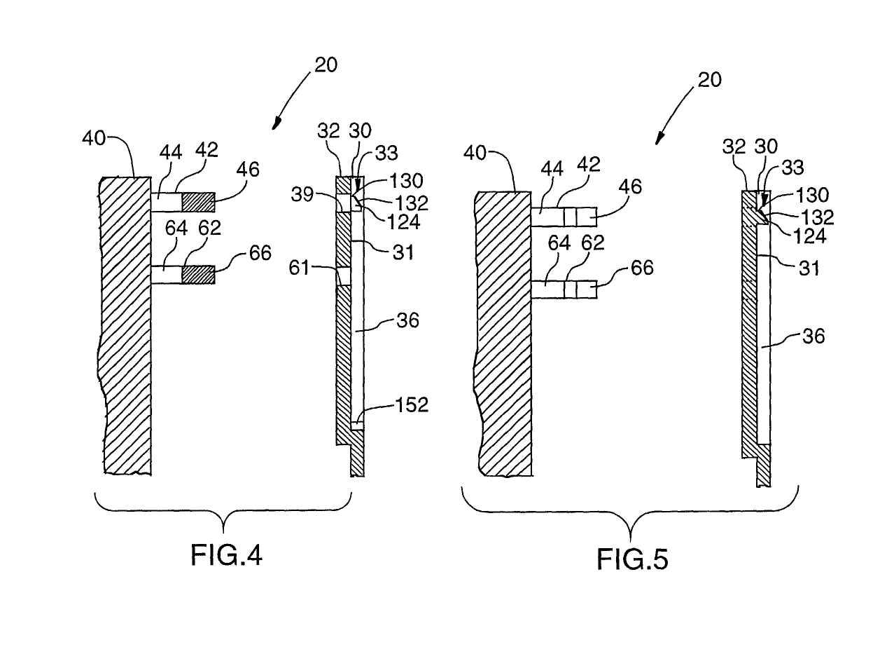

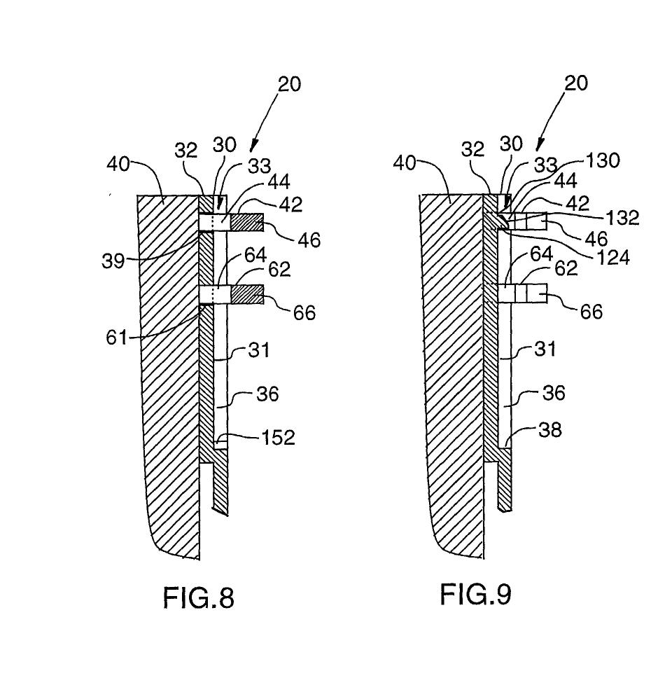

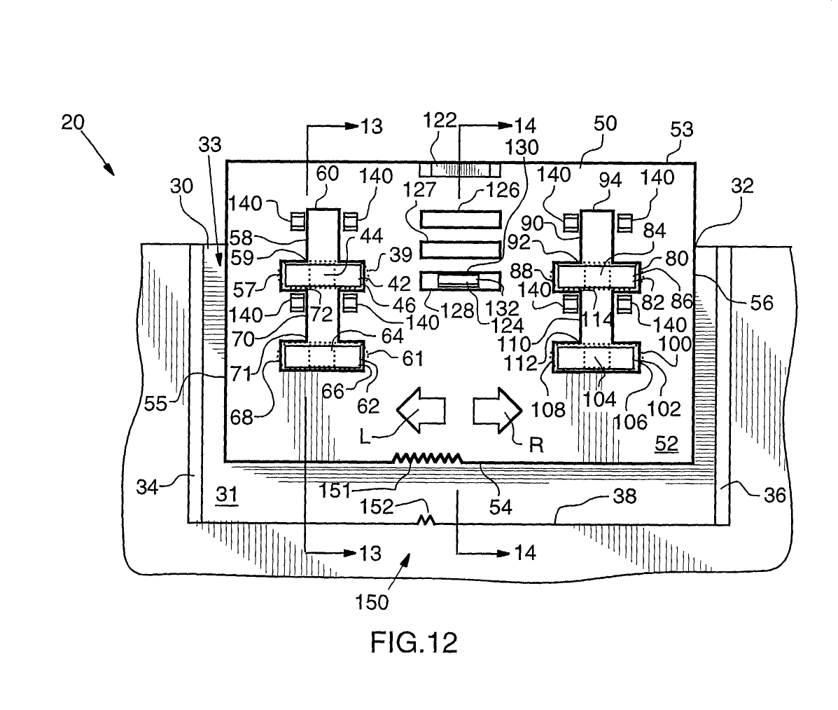

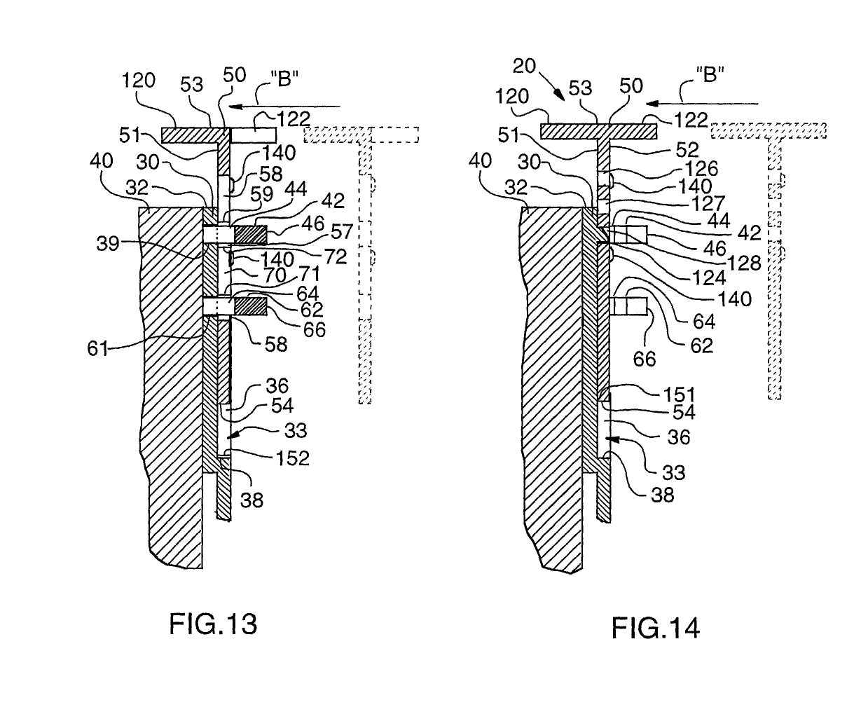

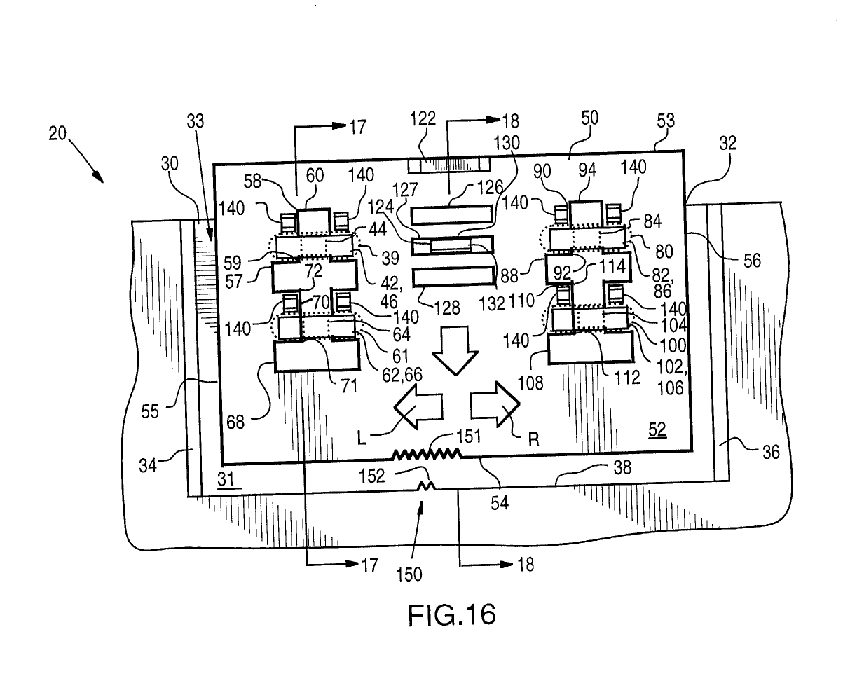

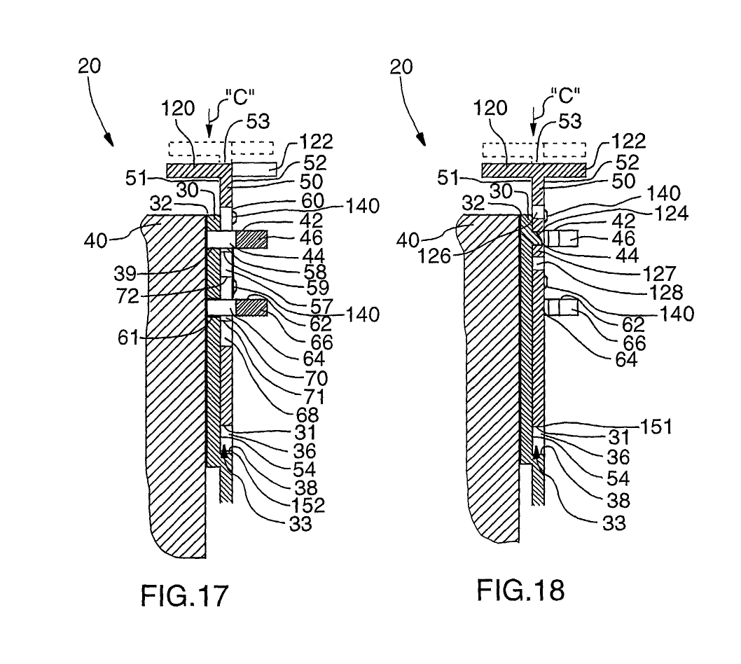

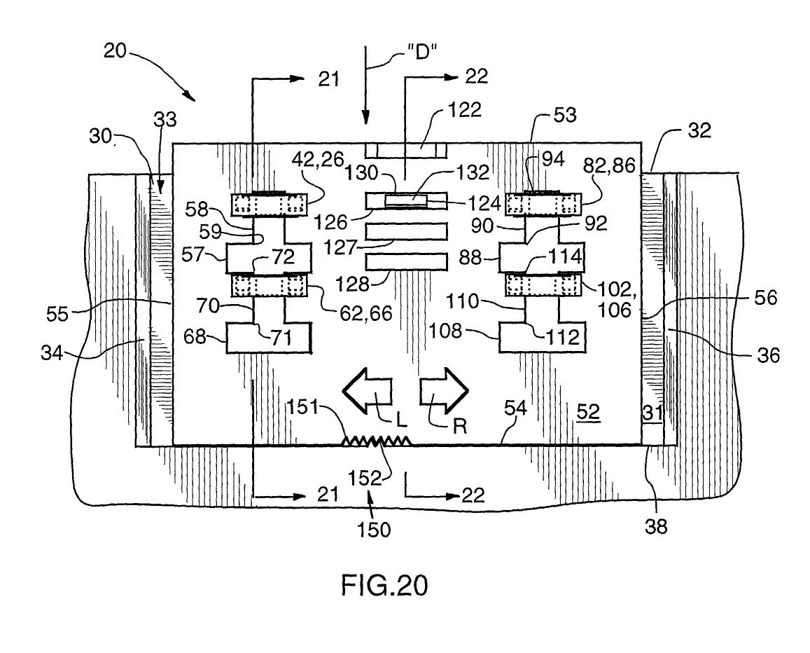

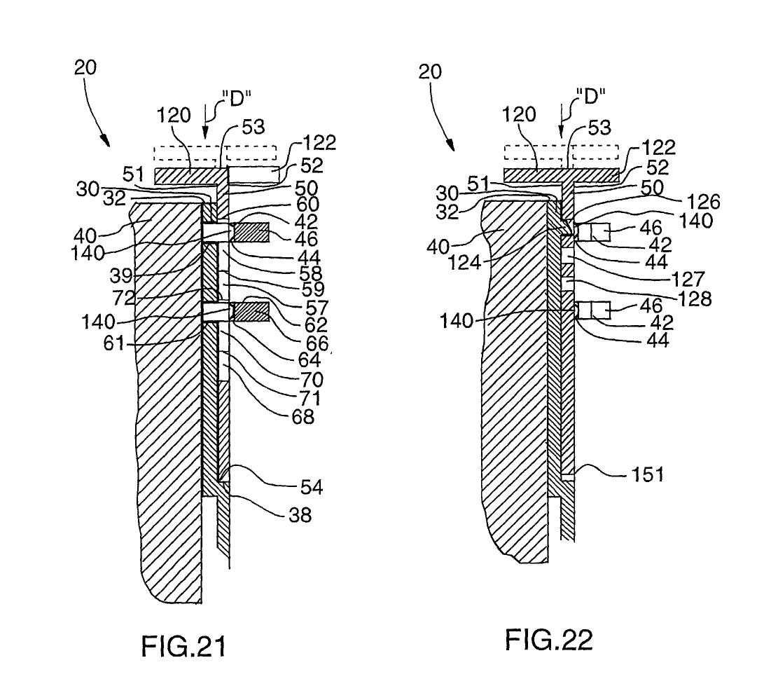

Referring now to FIGS. 1 through 22 of the drawings, a preferred embodiment horizontally adjustable fixture attachment system is shown, as indicated by the general reference numeral 20. The horizontally adjustable fixture attachment system 20 comprises a main body panel 30 defining a first plane 31 having a horizontal axis “H” and a vertical axis “V”. The first plane 31 is countersunk within the main body panel 30 adjacent a top free edge 32 of the main body panel 30 so as to form a substantially rectangular recess, as indicated by the general reference numeral 33, bounded by the top free edge 32, by left 34 and right 36 side perimeter walls, and by a bottom perimeter wall 38. A first aperture 39 extends through the main body panel 30, with the first aperture 39 having a horizontal width “WA₁”.

A fixture 40 for mounting on the main body panel 30 has a first tenon member 42 extending from the fixture 40. The first tenon member 42 has a shaft portion 44 with a horizontal width “WS₁” narrower than the horizontal width “WA₁” of the first aperture by a distance defining the horizontal adjustment of the fixture attachment system 20. The shaft portion 44 terminates in an enlarged head portion 46 having a horizontal width “WH₁” intermediate between the horizontal width “WS₁” of the shaft portion 44 and the horizontal width “WA₁” of the first aperture 39.

A locking plate 50 defines a first substantially planar face 51 and a second substantially planar face 52, and preferably is substantially rectangular in shape, having a top edge 53, a bottom edge 54, a left side edge 55, and a right side edge 56. The first 51 and second 52 planar faces are oriented substantially parallel to one another and are disposed, in all operative configurations, in substantially parallel overlapping relation to the first plane 31 of the main body panel 30, with the first planar face 51 being directed toward the main body panel 30. In operation, the locking plate 50 resides within the substantially rectangular recess 33 is shaped and dimensioned to receive the locking plate 50 therein.

The locking plate 50 has a horizontally extending first lower slot portion 57 dimensioned to permit the head portion 46 of the first tenon member 42 to pass through the first lower slot portion 57 when the fixture 40 and the locking plate 50 are placed relative to each other in an unlocked configuration. In its unlocked configuration, the main body panel 30 is interposed between the fixture 40 and the main body panel 30, the shaft portion of the first tenon member 42 is within the first aperture 39 and the first lower slot portion 57, and the head portion 46 of the tenon member 42 has passed through the first aperture 39 and the first lower slot portion 57 to protrude beyond the second substantially planar face 52 of the locking plate 50.

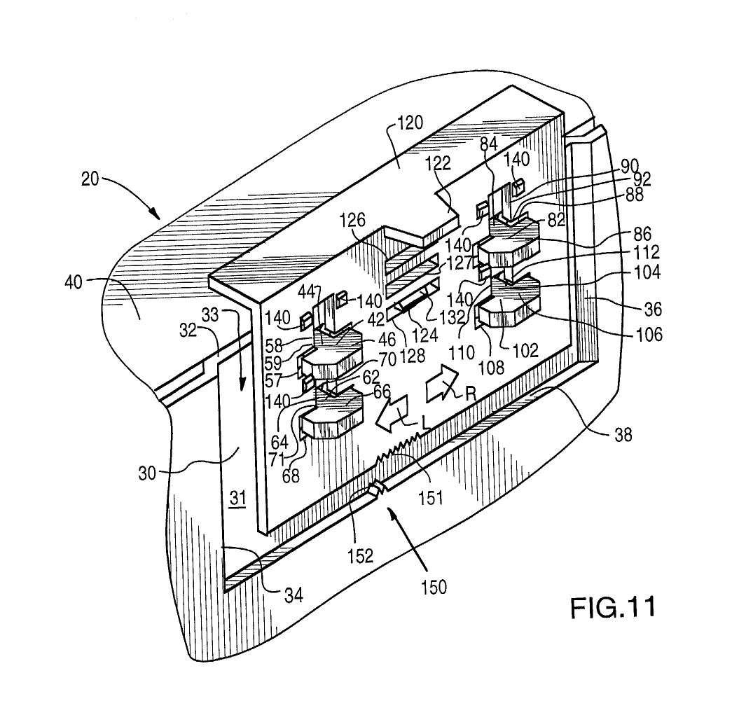

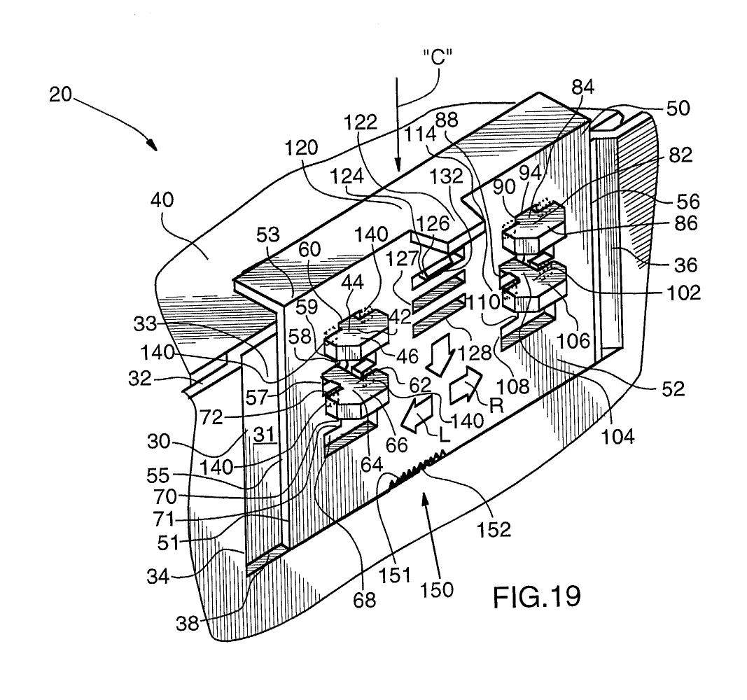

The locking plate 50 also has a first upper slot portion 58 extending from a lower end 59 coalescent with the first lower slot portion 51 and terminating in an upper end 60. The first upper slot portion 58 is horizontally dimensioned to receive the shaft portion 44 of the first tenon member 42 in horizontally close-fitting vertically sliding relation therewithin as the shaft portion 44 moves from the first lower slot portion 51 into the first upper slot portion 58 corresponding to the locking plate 50 being vertically moved relative to the fixture 40 and to the main body panel 30 from its initial unlocked configuration, as is best seen in FIGS. 11 through 14, to its locked configuration, as is best seen in FIGS. 19 through 22.

The first upper slot portion 58 is further horizontally dimensioned to preclude passage of the enlarged head portion 46 of the first tenon member 42 through the first upper slot portion 58, when the fixture 40, the main body panel 30 and the locking plate 50 are in the locked configuration.

The main body panel 30 further comprises a second aperture 61 extending through the main body panel 30 and having a horizontal width “WA₂”. The fixture 40 further comprises a second tenon member 62 extending from the fixture 40, the second tenon member 62 having a shaft portion 64 with a horizontal width “WS₂” narrower than the horizontal width of the second aperture 61 by a distance that permits the aforesaid horizontal adjustment of the fixture attachment system 20, as determined by the relative widths of the first aperture 39 (horizontal width “WA₁”) and the shaft portion 44 (horizontal width “WS₁”). The shaft portion 64 terminates in an enlarged head 66 portion having a horizontal width “WH₂” intermediate between the horizontal width “WS₂” of the shaft portion 64 and the horizontal width “WA₂” of the second aperture 61.

The locking plate 50 further comprises a second lower slot portion 68 dimensioned to permit the head portion 66 of the second tenon member 62 to pass through the second lower slot portion 68 when the fixture 40 and the locking plate 50 are placed relative to each other in an unlocked configuration. In this unlocked configuration, the main body panel 30 is interposed between the fixture 40 and the main body panel 30, the shaft portion 64 of the second tenon member 62 is within the second aperture 61 and the second lower slot portion 68, and the head portion 66 of the tenon member 62 has passed through the second aperture 61 and the second lower slot portion 68 to protrude beyond the second substantially planar face 52 of the locking plate 50.

A second upper slot portion 70 extends from a lower end 71 coalescent with the second lower slot portion 68 and terminates in an upper end 72. The second upper slot portion 70 is horizontally dimensioned to receive the shaft portion 64 of the second tenon member 62 in horizontally close-fitting vertically sliding relation therewithin as the shaft portion 64 moves from the second lower slot portion 68 into the second upper slot portion 70 corresponding to the locking plate 50 being vertically moved relative to the fixture 40 and to the main body panel 30 from the initial unlocked configuration, as shown in FIGS. 11 through 14, to its locked configuration, as is best seen in FIGS. 19 through 22.

The second upper slot portion 70 is further horizontally dimensioned to preclude passage of the enlarged head portion 66 of the second tenon member 62 through the second upper slot portion 70, when the fixture 40, the main body panel 30 and the locking plate 50 are in the locked configuration. The upper end of the second upper slot portion 70 is coalescent with the first lower slot portion 51.

In the preferred embodiment illustrated, the first 39 and second 61 apertures are substantially identical one to the other, the first 42 and second 62 tenon members are substantially identical one to the other, the first 57 and second 68 lower slot portions are substantially identical one to the other, and the first 58 and second 70 upper slot portions are substantially identical one to the other, for the purposes of ease of manufacture, and ease of assembly, among other reasons.

The main body panel 30 further comprises a third aperture 80 extending through the main body panel 30 and having a horizontal width “WA₃”. The fixture 40 further comprises a third tenon member 82 extending from the fixture 40, the third tenon member 82 having a shaft portion 84 with a horizontal width “WS₃” narrower than the horizontal width “WA₃” of the third aperture 80 by a distance permitting the horizontal adjustment of the fixture attachment system 20. The shaft portion 84 terminates in an enlarged head portion 86 having a horizontal width “WH₃” intermediate between the horizontal width “WS₃” of the shaft portion 84 and the horizontal width “WA₃” of the third aperture 80.

The locking plate 50 further comprises a third lower slot portion 88 dimensioned to permit the enlarged head portion 86 of the third tenon member 82 to pass through the third lower slot portion 88 when the fixture 40 and the locking plate 50 are placed relative to each other in an unlocked configuration. In the unlocked configuration, the main body panel 30 is interposed between the fixture 40 and the main body panel 30, the shaft portion 84 of the third tenon member 82 is within the third aperture 80 and the third lower slot portion 88, and the head portion 86 of the third tenon member 82 has passed through the third aperture 80 and the third slot to protrude beyond the second substantially planar face 52 of the locking plate 50.

A third upper slot portion 90 extends from a lower end 92 coalescent with the third lower slot portion 88 and terminates in an upper end 94. The third upper slot portion 90 being horizontally dimensioned to receive the shaft portion 84 of the third tenon member 82 in horizontally close-fitting vertically sliding relation therewithin, as the shaft portion 84 moves from the third lower slot portion 88 into the third upper slot portion 90, corresponding to the locking plate 50 being vertically moved relative to the fixture 40 and to the main body panel 30 from the initial unlocked configuration, as shown in FIGS. 11 through 14, to its locked configuration, as is best seen in FIGS. 19 through 22. The third upper slot portion 90 is further horizontally dimensioned to preclude passage of the head portion 86 of the third tenon member 82 through the third upper slot portion 90, when the fixture 40, the main body panel 30 and the locking plate 50 are in the locked configuration.

The main body panel 30 further comprises a fourth aperture 100 extending through the main body panel 30 and having a horizontal width “WA₄”. The fixture 40 further comprises a fourth tenon member 102 extending from the fixture 40, the fourth tenon member 102 having a shaft portion 104 with a horizontal width “WS₄” narrower than the horizontal width “WA₄” of the fourth aperture 100 by a distance permitting the horizontal adjustment of the fixture attachment system 20. The shaft portion terminates in an enlarged head portion 106 having a horizontal width “WH₄” intermediate between the horizontal width “WS₄” of the shaft portion 104 and the horizontal width “WA₄” of the fourth aperture 100.

The locking plate 50 further comprises a fourth lower slot portion 108 dimensioned to permit the enlarged head portion 106 of the fourth tenon member 102 to pass through the fourth lower slot portion 108 when the fixture 40 and the locking plate 50 are placed relative to each other in an unlocked configuration. In the ulocked configuration, the main body panel 30 is interposed between the fixture 40 and the main body panel 30, the shaft portion 104 of the tenon member 102 is within the fourth aperture 100 and the fourth lower slot portion 108, and the head portion of the tenon member has passed through the fourth aperture 100 and the fourth lower slot portion 108 to protrude beyond the second substantially planar face 52 of the locking plate 50.

A fourth upper slot portion 110 extends from a lower end 112 coalescent with the fourth lower slot portion 108 and terminates in an upper end 114, whereat the upper end 114 of the fourth upper slot portion 110 is coalescent with the third lower slot portion 88. The fourth upper slot portion 110 is horizontally dimensioned to receive the shaft portion 104 of the fourth tenon member 102 in horizontally close-fitting vertically sliding relation therewithin, as the shaft portion 104 moves from the fourth lower slot portion 108 into the fourth upper slot portion 110 corresponding to the locking plate 50 being vertically moved relative to the fixture 40 and to the main body panel 30, from the initial unlocked configuration, as shown in FIGS. 11 through 14, to its locked configuration, as is best seen in FIGS. 19 through 22.

The fourth upper slot portion 110 is further horizontally dimensioned to preclude passage of the enlarged head portion 106 of the fourth tenon member 102 through the fourth upper slot portion 110, when the fixture 40, the main body panel 30 and the locking plate 50 are in the locked configuration.

In the preferred embodiment, for reasons of manufacturing and subsequent assembly of the fixture attachment system 20, the first 39, second 61, third 80 and fourth 100 apertures are substantially identical one to another, and the first 42, second 62, third 82 and fourth 102 tenon members are substantially identical one to another. Further, the first 57, second 68, third 88 and fourth 108 lower slot portions are substantially identical one to another, and the first 58, second 70, third 90 and fourth 110 upper slot portions are substantially identical one to another.

Also, for reasons of manufacturing and subsequent assembly of the fixture attachment system 20, the first 39, second 61, third 80 and fourth 100 apertures in the main body panel 30 are arranged in a rectangular pattern, the first 42, second 62, third 82 and fourth 102 tenon members are arranged in the same rectangular pattern. Further, the first 57, second 68, third 88 and fourth 108 lower slot portions in the locking plate 50 are arranged in the same rectangular pattern, and the first 58, second 70, third 90 and fourth 110 upper slot portions in the locking plate 50 are arranged in the same rectangular pattern.

The locking plate 50 further comprises a flange portion 120 disposed adjacent the top edge 53 of the locking plate 50. In use, the flange portion 120 extends substantially transversely outwardly from the first substantially planar face 51 of the locking plate 50 so as to overlie the top free edge 32 of the main body panel 30 when the locking plate 50 is in the locked configuration.

The locking plate 50 also comprises a tab portion 122 extending substantially transversely outwardly from the second planar face of the locking plate 50, in a direction substantially opposite to the flange portion 120. The tab portion 122 is preferably disposed also adjacent the top edge 53 of the locking plate 50. The flange portion 120 and the tab portion 122 are used to manually manipulate the locking plate 50, so as to vertically move the locking plate 50 relative to the fixture 40 and to the main body panel 30, from the initial unlocked configuration, as shown in FIGS. 11 through 14, to its locked configuration, as is best seen in FIGS. 19 through 22.

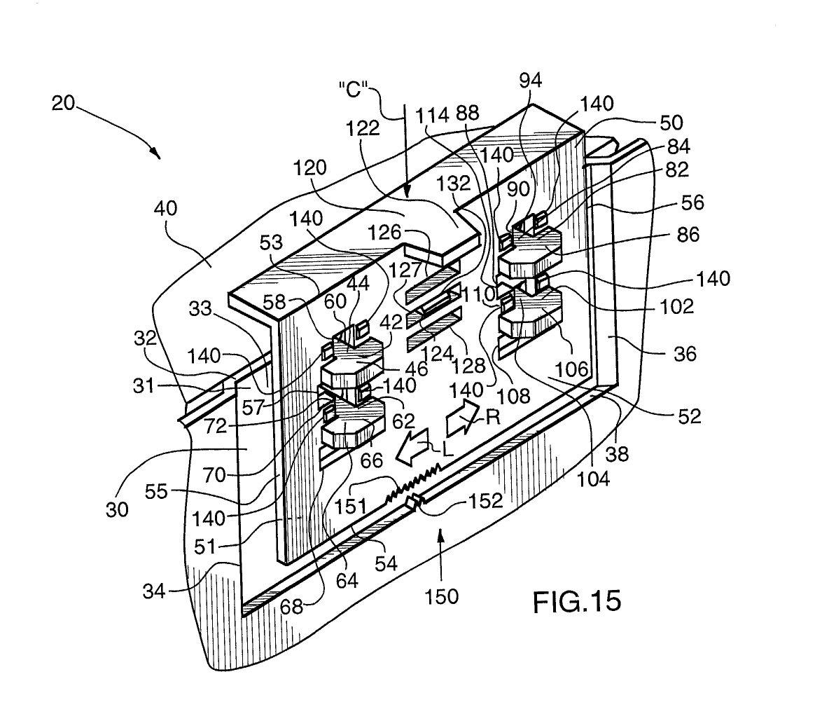

There is also a vertical positioning detent member 124 disposed on the main body panel 30, and an upper detent receiving aperture 126, an intermediate detent receiving aperture 127, and a lower detent receiving aperture 128 are disposed in the locking plate 50, in vertical alignment one with the other. The vertical positioning detent member 124 is disposed on the main body panel 30 so as to, in use, contact the locking plate 50, and more specifically engage the upper 126, intermediate 127, and lower 128 detent receiving apertures. Each of the upper 126, intermediate 127, and lower 128 detent receiving apertures is shaped and dimensioned to receive the vertical positioning detent member 124 therein. The vertical positioning detent member 124 is received in the lower detent receiving aperture 128 when the locking plate 50 is moved to its unlocked configuration, as is best seen in FIGS. 11 through 14. The vertical positioning detent member 124 is received in the intermediate detent receiving aperture 127 when the locking plate 50 is moved to an intermediate position between the locked configuration and the unlocked configuration, as is best seen in FIGS. 15 through 18. The vertical positioning detent member 124 is received in the upper detent receiving aperture 126 when the locking plate 50 is moved to its locked configuration, as is best seen in FIGS. 19 through 22

The vertical positioning detent member 124 comprises a top surface 130 that terminates in a downwardly sloped portion 132. The downwardly sloped portion 132 facilitates downwardly directed removal of the locking plate 50 from the vertical positioning detent member 124, when the vertical positioning detent member 124 is in the lower detent receiving aperture 128 and the locking plate 50 is being moved downwardly from its unlocked configuration to an intermediate position between the unlocked configuration and the locked configuration, and when the vertical positioning detent member 124 is in the intermediate detent receiving aperture 127 and the locking plate 50 is being moved downwardly from its intermediate position to its locked configuration.

There is a first latching means comprising a pair of locking detent members 140 mounted on the second substantially planar face 52 of the locking plate 50 adjacent to the first upper slot portion 58, a second latching means comprising a pair of locking detent members 140 mounted on the second substantially planar face 52 of the locking plate 50 adjacent to the second upper slot portion 70, a third latching means comprising a pair of locking detent members 140 mounted on the second substantially planar face 52 of the locking plate 50 adjacent to the third upper slot portion 90, and a fourth latching means comprising a pair of locking detent members 140 mounted on the second substantially planar face 52 of the locking plate 50 adjacent to the fourth upper slot portion 110. More specifically, one detent member 140 is mounted on each elongate side of each of the first 58, second 70, third 90 and fourth 110 upper slot portions in the locking plate 50. The locking detent members 140 are disposed, as described, for frictional engagement of the first 46, second 66, third 86 and fourth 106 enlarged head portions of the first 42, second 62, third 82 and fourth 102 tenon members, respectively, as the first 42, second 62, third 82 and fourth 102 tenon members of the first 44, second 64, third 84 and fourth 104 shaft portions, respectively, vertically move towards the first 58, second 70, third 90 and fourth 110 upper slot portions, corresponding to the locking plate 50 being vertically moved relative to the fixture 40 and to the main body panel 30 from the initial unlocked configuration, as shown in FIGS. 11 through 14, to the locked configuration, as is best seen in FIGS. 19 through 22. The frictional engagement holds the first 42, second 62, third 82 and fourth 102 tenon members in vertically unmovable relation adjacent the respective upper ends 60, 72, 94, and 114 of first 58, second 70, third 90 and fourth 110 upper slot portions in the locking plate 50, to prevent reverse vertical movement of the first 44, second 64, third 84 and fourth 104 shaft portions relative to the respective first 58, second 70, third 90 and fourth 110 upper slot portions, thereby to preclude movement of the fixture 40 and the locking plate 50 with respect to each other.

A contact means, as indicated by the general reference numeral 150, has a first cooperating portion, specifically a first series of teeth 151, and a second cooperating portion, specifically a second series of teeth 152, mounted one cooperating portion on each of the locking plate 50 and the main body panel 30. In the preferred embodiment illustrated, the first series of teeth 151 is mounted along the bottom edge of the locking plate 50, and the second series of teeth 152 is mounted on the bottom perimeter wall 38 of the substantially rectangular recess 33 on the main body panel 30.

The first 151 and second 152 series of teeth are mounted as such to engage one another in horizontally fixed relation when the fixture 40 and the locking plate 50 are in the locked configuration, thereby to preclude horizontal movement of the locking plate 50 and the fixture 40 relative to the main body panel 30. In this manner, the horizontally positioning of the fixture 40 may be adjusted during installation, and then fixed in place by the contact means 150, namely the first 151 and second 152 series of teeth.

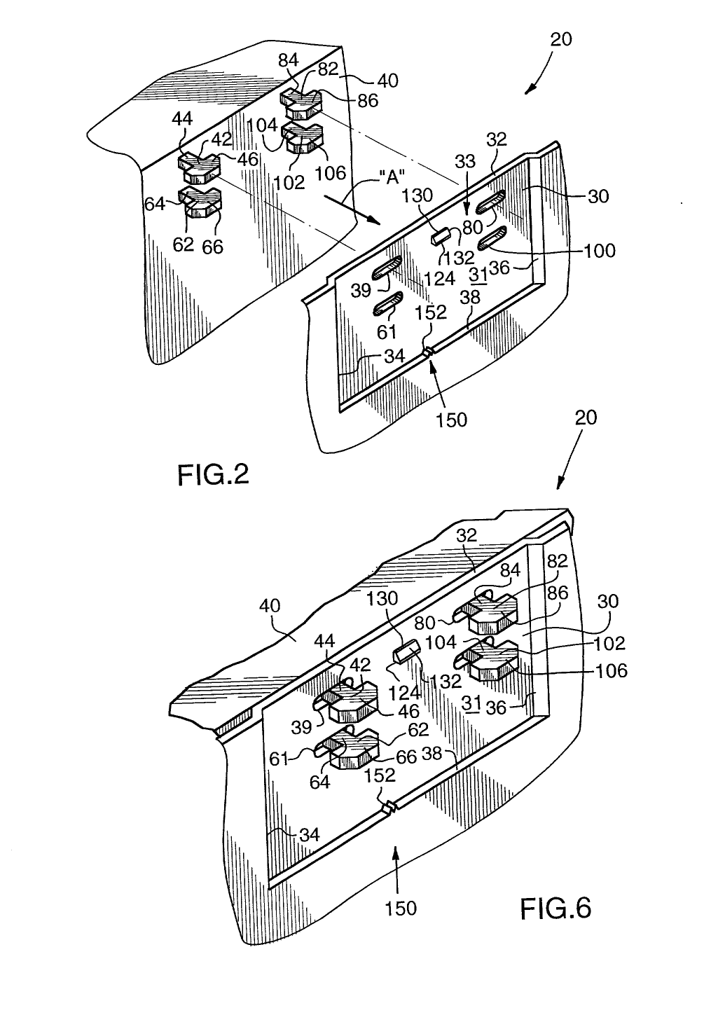

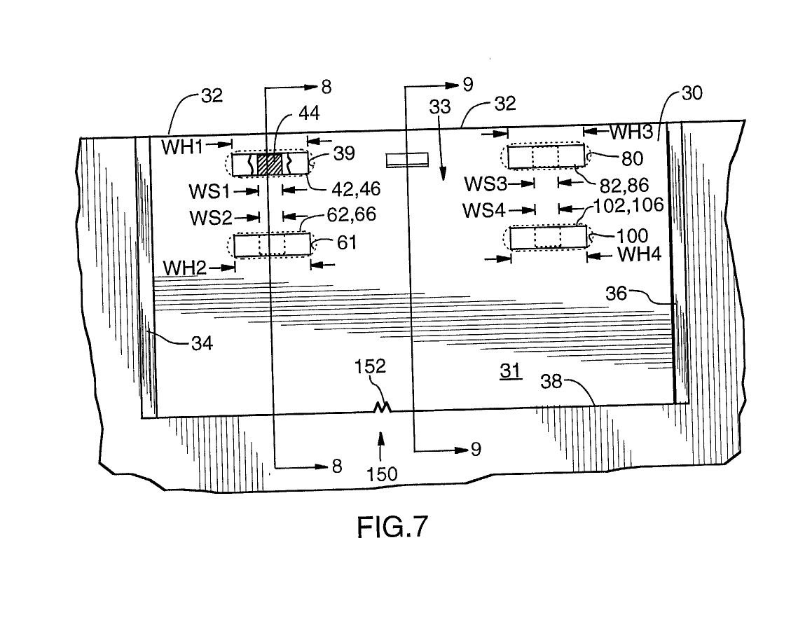

In use, as indicated by arrow “A” in FIG. 2, the fixture 40 is brought into contact with the main body panel 30 so as to be mounted thereon. The first tenon member 42 enters the first aperture 39, the second tenon member 62 enters the second aperture 61, the third tenon member 82 enters the third aperture 80, and the fourth tenon member 102 enters the fourth aperture 100. The enlarged head portions 46, 66, 86, and 106 of the first tenon member 42, the second tenon member 62, the third tenon member 82, and the fourth tenon member 102, respectively, pass through the first aperture 39, the second aperture 61, the third aperture 80, and the fourth aperture 100, respectively, so as to protrude therebeyond, as can be seen in FIGS. 6 through 9.

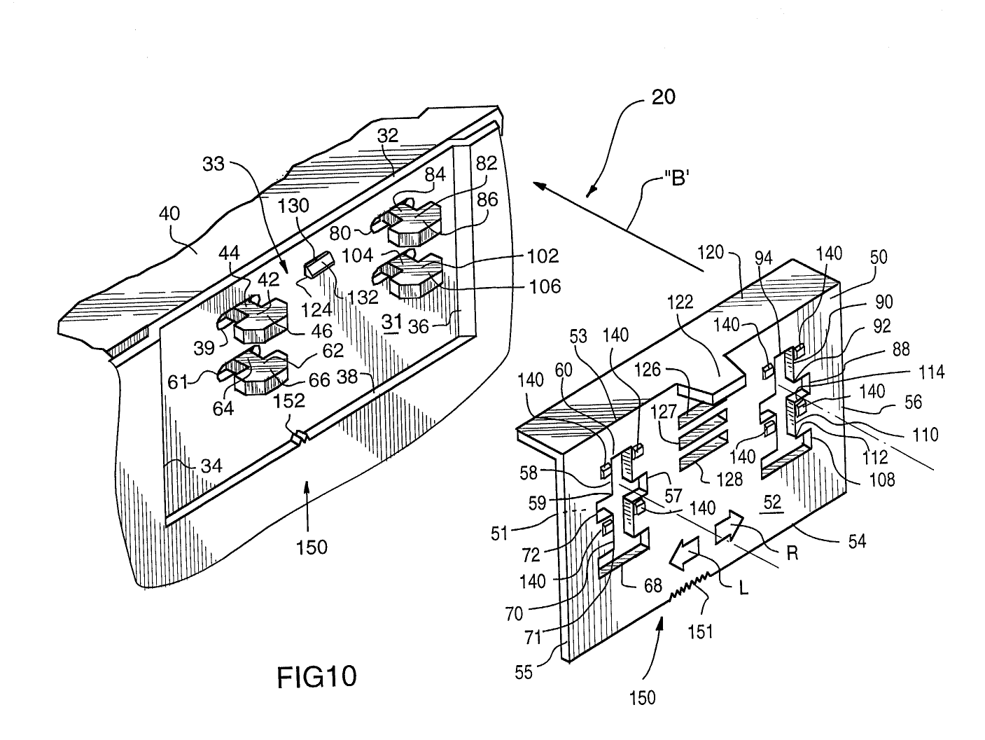

As can be best seen in FIGS. 10, 13 and 14, the locking plate 50 is then brought into contact with the second planar face 50 of the main body panel 30 so as to be received within the substantially rectangular recess 33, as indicated by arrows “B”, and so as to be positioned as shown in FIGS. 11 through 14. This is the unlocked configuration of the locking plate 50. As can be best seen in FIGS. 11 through 14, the vertical positioning detent member 124 is disposed within the lower detent receiving aperture 128.

As indicated by arrows “C” in FIGS. 15 through 18, the locking plate 50 is pushed downwardly such that the vertical positioning detent member 124 no longer is disposed within the lower detent receiving aperture 128 and such that the locking plate 50 is no longer in its unlocked configuration. The shaft portions 44, 64, 84, and 104 of the first 42, second 62, third 82, and fourth 102 tenon members enter the first 58, second 70, third 70, and fourth 110 upper slot portions, respectively, in horizontally close-fitting vertically sliding relation. In the intermediate configuration, the passage of the head portions 46, 66, 86, and 106 of the first 42, second, 62, third 82, and fourth 102 tenon members is precluded by the width of each of the respective first 58, second 70, third 90, and fourth 110 upper slot portions. The locking plate 50 is in an intermediate configuration between its unlocked configuration and locked configuration. Correspondingly, the vertical positioning detent member 124 is disposed within the intermediate detent receiving aperture 127. In this configuration, the fixture 40 and the locking plate 50 can be adjusted horizontally, either leftward, as indicated by arrow “L”, or rightward, as indicated by arrow “R”, to a desired horizontal position.

As indicated by arrows “D” in FIGS. 19 through 22, the locking plate 50 has been moved from the intermediate configuration to its locked configuration whereat the vertical positioning detent member 124 is disposed in the upper detent receiving aperture 126 and the first series of teeth 151 on the locking plate 150 engages the second series of teeth 152 on the bottom perimeter wall 38 of the substantially rectangular recess on the main body panel 30. The locking detent members 140 engage the enlarged head portions 46, 66, 86, and 106, of the first tenon member 42, the second tenon member 62, the third tenon member 82, and the fourth tenon member 102, respectively, in horizontally fixed relation, when the fixture 40 and the locking plate 50 are in the locked configuration, so as to thereby preclude movement of the fixture 40 and the locking plate 50 with respect to each other.

Other modifications and alterations may be used in the design and manufacture of the horizontally adjustable fixture attachment system according to the present invention without departing from the spirit and scope of the invention, which is limited only by the accompanying claims.

I claim:

1. A horizontally adjustable fixture attachment system comprising:
a main body panel defining a first plane having horizontal and vertical axes and including a first aperture extending through said panel, said first aperture having a horizontal width;
a fixture for mounting on said main body panel and having a first tenon member extending from said fixture, said first tenon member having a shaft portion with a horizontal width narrower than the horizontal width of said first aperture by a distance defining the horizontal adjustment of said fixture attachment system, said shaft portion terminating in an enlarged head portion having a horizontal width intermediate between the horizontal width of said shaft portion and the horizontal width of said first aperture;
a locking plate defining first and second substantially planar faces, said planar faces being oriented substantially parallel to one another and being disposed, in all operative configurations, in substantially parallel overlapping relation to said first plane, with said first planar face being directed toward said main body panel;
said locking plate having a horizontally extending first lower slot portion dimensioned to permit the head portion of said first tenon member to pass through said first lower slot portion when said fixture and said locking plate are placed relative to each other in an unlocked configuration, in which configuration said main body panel is interposed between said fixture and said main body panel, said shaft portion of said first tenon member is within said first aperture and said first lower slot portion, and said head portion of the first tenon member has passed through said first aperture and said first lower slot portion to protrude beyond said second planar face of the locking plate;
said locking plate having a first upper slot portion extending from a lower end coalescent with said first lower slot portion and terminating in an upper end, said first upper slot portion being horizontally dimensioned to receive the shaft portion of said first tenon member in horizontally close-fitting vertically sliding relation therewithin as said shaft portion moves from said first lower slot portion into said first upper slot portion corresponding to said locking plate being vertically moved relative to said fixture and to said body panel from said initial unlocked configuration to a locked configuration;
said first upper slot portion being further horizontally dimensioned to preclude passage of said head portion of the first tenon member through said first upper slot portion, when said fixture, said main body panel and said locking plate are in said locked configuration;
first latching means mounted on the second substantially planar face of said locking plate adjacent to said first upper slot portion for frictional engagement of said head portion of the first tenon member as said shaft portion vertically moves towards said upper end of said first upper slot portion corresponding to said locking plate being vertically moved relative to said fixture and to said main body panel from said unlocked configuration to said locked configuration, said frictional engagement holding said first tenon member in vertically unmovable relation adjacent said upper end of said slot portion to prevent reverse vertical movement of said shaft portion relative to said first upper slot portion, thereby to preclude movement of said fixture and said locking plate with respect to each other; and,
a contact means having first and second cooperating portions mounted one on each of said locking plate and said main body panel to engage one another in horizontally fixed relation when said fixture and said locking plate are in said locked configuration, thereby to preclude horizontal movement of said locking plate and said fixture relative to said main body panel.

2. The horizontally adjustable fixture attachment system of claim 1, wherein said first cooperating portion of said contact means comprises a first series of teeth and said second cooperating portion of said contact means comprises a second series of teeth.

3. The horizontally adjustable fixture attachment system of claim 2, wherein said first series of teeth is mounted on said locking plate and said second series of teeth is mounted on said main body panel.

4. The horizontally adjustable fixture attachment system of claim 3, wherein said locking plate is substantially rectangular and is defined by top, bottom, left side and right side edges.

5. The horizontally adjustable fixture attachment system of claim 4, wherein said first series of teeth is mounted along the bottom edge of said locking plate.

6. The horizontally adjustable fixture attachment system of claim 5, wherein said first plane is countersunk within said main body panel adjacent a top free edge of said main body panel so as to form a substantially rectangular recess bounded by said top free edge, by left and right side perimeter walls, and by a bottom perimeter wall, and wherein said substantially rectangular recess is shaped and dimensioned to receive said locking plate therein.

7. The horizontally adjustable fixture attachment system of claim 6, wherein said second series of teeth is disposed on said bottom perimeter wall of said substantially rectangular recess.

8. The horizontally adjustable fixture attachment system of claim 7, wherein said locking plate further comprises a flange portion disposed adjacent the top edge of said locking plate, which flange portion, in use, extends substantially transversely outwardly from said first planar face of said locking plate so as to overlie said top free edge of said main body panel when said locking plate is in said locked configuration.

9. The horizontally adjustable fixture attachment system of claim 8, wherein said locking plate further comprises a tab portion extending substantially transversely outwardly from said second planar face of said locking plate, in a direction substantially opposite to said flange portion.

10. The horizontally adjustable fixture attachment system of claim 9, wherein said tab member is disposed adjacent said top edge of said locking plate.

11. The horizontally adjustable fixture attachment system of claim 10, further comprising a vertical positioning detent member disposed on said main body panel so as to, in use, contact said locking plate, and also comprising upper, intermediate, and lower detent receiving apertures in said locking plate, wherein each of said upper, intermediate, and lower detent receiving apertures is shaped and dimensioned to receive said vertical positioning detent member therein, wherein said vertical positioning detent member is received in said upper detent receiving aperture when said locking plate is moved to its unlocked configuration, wherein said vertical positioning detent member is received in said intermediate detent receiving aperture when said locking plate is moved to an intermediate position between said locked configuration and said unlocked configuration, and wherein said vertical positioning detent member is received in said lower detent receiving aperture when said locking plate is moved to its locked configuration.

12. The horizontally adjustable fixture attachment system of claim 11, wherein said vertical positioning detent member comprises a top surface that terminates in a downwardly sloped portion that facilitates downwardly directed removal of said locking plate from said vertical positioning detent member, when said vertical positioning detent member is in said upper detent receiving aperture and said locking plate is being moved downwardly from its unlocked configuration to an intermediate position between said unlocked configuration and said locked configuration, and when said vertical positioning detent member is in said intermediate detent receiving aperture and said locking plate is being moved downwardly from said intermediate position to said locked configuration.

13. The horizontally adjustable fixture attachment system of claim 12, wherein said main body panel further comprises a second aperture extending through said main body panel and having a horizontal width,
said fixture further comprises a second tenon member extending from said fixture, said second tenon member having a shaft portion with a horizontal width narrower than the horizontal width of said second aperture by a distance permitting said horizontal adjustment of said fixture attachment system, said shaft portion terminating in an enlarged head portion having a horizontal width intermediate between the horizontal width of said shaft portion and the horizontal width of said second aperture;
said locking plate further comprises a second lower slot portion dimensioned to permit the head portion of said second tenon member to pass through said second lower slot portion when said fixture and said locking plate are placed relative to each other in said unlocked configuration, said shaft portion of said second tenon member is within said second aperture and said second lower slot portion, and said head portion of the second tenon member has passed through said second aperture and said second lower slot portion to protrude beyond said second planar face of the locking plate;
a second upper slot portion extending from a lower end coalescent with said second lower slot portion and terminating in an upper end, said second upper slot portion being horizontally dimensioned to receive the shaft portion of said second tenon member in horizontally close-fitting vertically sliding relation therewithin as said shaft portion moves from said second lower slot portion into said second upper slot portion corresponding to said locking plate being vertically moved relative to said fixture and to said body panel from said initial unlocked configuration to said locked configuration, said second upper slot portion being further horizontally dimensioned to preclude passage of said head portion of the second tenon member through said second upper slot portion, when said fixture, said main body panel and said locking plate are in said locked configuration; and,
second latching means mounted on the second substantially planar face of said locking plate adjacent to said second upper slot portion for frictional engagement of said head portion of the second tenon member as said shaft portion vertically moves towards said upper end of said second upper slot portion corresponding to said locking plate being vertically moved relative to said fixture and to said main body panel from said unlocked configuration to said locked configuration, said frictional engagement holding said second tenon member in vertically unmovable relation adjacent said upper end of said slot portion to prevent reverse vertical movement of said shaft portion relative to said second upper slot portion, thereby to preclude movement of said fixture and said locking plate with respect to each other.

14. The horizontally adjustable fixture attachment system of claim 13, wherein said upper end of said second upper slot portion is coalescent with said first lower slot portion.

15. The horizontally adjustable fixture attachment system of claim 14, wherein said first and second apertures are substantially identical one to the other, said first and second tenon members are substantially identical one to the other, said first and second lower slot portions are substantially identical one to the other, and said first and second upper slot portions are substantially identical one to the other.

16. The horizontally adjustable fixture attachment system of claim 15, wherein said main body panel further comprises a third aperture extending through said main body panel and having a horizontal width,
said fixture further comprises a third tenon member extending from said fixture, said third tenon member having a shaft portion with a horizontal width narrower than the horizontal width of said third aperture by a distance permitting said horizontal adjustment of said fixture attachment system, said shaft portion terminating in an enlarged head portion having a horizontal width intermediate between the horizontal width of said shaft portion and the horizontal width of said third aperture;
said locking plate further comprises a third lower slot portion dimensioned to permit the head portion of said third tenon member to pass through said third lower slot portion when said fixture and said locking plate are placed relative to each other in said unlocked configuration, said shaft portion of said third tenon member is within said third aperture and said third lower slot portion, and said head portion of the third tenon member has passed through said third aperture and said third lower slot portion to protrude beyond said second planar face of the locking plate;
a third upper slot portion extending from a lower end coalescent with said third lower slot portion and terminating in an upper end, said third upper slot portion being horizontally dimensioned to receive the shaft portion of said third tenon member in horizontally close-fitting vertically sliding relation therewithin as said shaft portion moves from said third lower slot portion into said third upper slot portion corresponding to said locking plate being vertically moved relative to said fixture and to said body panel from said initial unlocked configuration to said locked configuration, said third upper slot portion being further horizontally dimensioned to preclude passage of said head portion of the third tenon member through said third upper slot portion, when said fixture, said main body panel and said locking plate are in said locked configuration; and,
third latching means mounted on the second substantially planar face of said locking plate adjacent to said third upper slot portion for frictional engagement of said head portion of the third tenon member as said shaft portion vertically moves towards said upper end of said third upper slot portion corresponding to said locking plate being vertically moved relative to said fixture and to said main body panel from said unlocked configuration to said locked configuration, said frictional engagement holding said third tenon member in vertically unmovable relation adjacent said upper end of said slot portion to prevent reverse vertical movement of said shaft portion relative to said third upper slot portion, thereby to preclude movement of said fixture and said locking plate with respect to each other.

17. The horizontally adjustable fixture attachment system of claim 16, wherein said main body panel further comprises a fourth aperture extending through said main body panel and having a horizontal width,
said fixture further comprises a fourth tenon member extending from said fixture, said fourth tenon member having a shaft portion with a horizontal width narrower than the horizontal width of said fourth aperture by a distance permitting said horizontal adjustment of said fixture attachment system, said shaft portion terminating in an enlarged head portion having a horizontal width intermediate between the horizontal width of said shaft portion and the horizontal width of said fourth aperture;
said locking plate further comprises a fourth lower slot portion dimensioned to permit the head portion of said fourth tenon member to pass through said fourth lower slot portion when said fixture and said locking plate are placed relative to each other in said unlocked configuration, said shaft portion of said fourth tenon member is within said fourth aperture and said fourth lower slot portion, and said head portion of the third tenon member has passed through said fourth aperture and said fourth lower slot portion to protrude beyond said second planar face of the locking plate;
a fourth upper slot portion extending from a lower end coalescent with said fourth lower slot portion and terminating in an upper end, said fourth upper slot portion being horizontally dimensioned to receive the shaft portion of said fourth tenon member in horizontally close-fitting vertically sliding relation therewithin as said shaft portion moves from said fourth lower slot portion into said fourth upper slot portion corresponding to said locking plate being vertically moved relative to said fixture and to said body panel from said initial unlocked configuration to said locked configuration, said fourth upper slot portion being further horizontally dimensioned to preclude passage of said head portion of the third tenon member through said fourth upper slot portion, when said fixture, said main body panel and said locking plate are in said locked configuration; and,
fourth latching means mounted on the second substantially planar face of said locking plate adjacent to said fourth upper slot portion for frictional engagement of said head portion of the fourth tenon member as said shaft portion vertically moves towards said upper end of said fourth upper slot portion corresponding to said locking plate being vertically moved relative to said fixture and to said main body panel from said unlocked configuration to said locked configuration, said frictional engagement holding said fourth tenon member in vertically unmovable relation adjacent said upper end of said slot portion to prevent reverse vertical movement of said shaft portion relative to said fourth upper slot portion, thereby to preclude movement of said fixture and said locking plate with respect to each other.

18. The horizontally adjustable fixture attachment system of claim 17, wherein said upper end of said fourth upper slot portion is coalescent with said third lower slot portion.

19. The horizontally adjustable fixture attachment system of claim 18, wherein said first, second, third and fourth apertures in said main body panel are arranged in a rectangular pattern, said first, second, third and fourth tenon members are arranged in said rectangular pattern, said first, second, third and fourth lower slot portions in said locking plate are arranged in said rectangular pattern, and said first, second, third and fourth upper slot portions in said locking plate are arranged in said rectangular pattern.

20. The horizontally adjustable fixture attachment system of claim 19, wherein said first, second, third and fourth apertures are substantially identical one to another, said first, second, third and fourth tenon members are substantially identical one to another, said first, second, third and fourth lower slot portions are substantially identical one to another, and said first, second, third and fourth upper slot portions are substantially identical one to another.

21. The horizontally adjustable fixture attachment system of claim 20, wherein said first latching means, said second latching means, said third latching means, and said fourth latching means each comprises a pair of locking detent members disposed one on each side of said first, second, third, and fourth upper slot portions, respectively.
